(19) United States
(12) Patent Application Publication
(10) Pub. No.: US 2005/0006552 A1
(43) Pub. Date: Jan. 13, 2005

(54) Soft pad picture mount

(76) Inventor: Edward Giles, Chicago, IL (US)

Correspondence Address: DAVID J. BREMER, 4518 N. DAMEN AVENUE, CHICAGO, IL, 60525, US

(21) Appl. No.: 10/618,489

(22) Filed: Jul. 11, 2003

(51) Int. Cl. B60R 1/02

(52) U.S. Cl. 248/467; 248/217.3; 248/205.3

(57) ABSTRACT

The invention is a support product for hanging and holding unmounted media such as photographs, postcards, index cards, and other media. The support product provides secure, repositionable, and nonpermanent support by interposing a conforming pad between the unmounted medium and the mounting surface and by engaging the mounting surface with a fastener extending outwardly from the conforming pad.

The invention is a support product for hanging and holding unmounted media such as photographs, postcards, index cards, and other media. The support product provides secure, repositionable, and nonpermanent support without damaging the media.

Many types of unmounted media, for example photographs, postcards, index cards and various other media have unrestrained shapes that are substantially non-flat. The non-flat unrestrained shapes make it difficult to securely hang and hold the unmounted medium with a releasable adhesive. Over time the medium tends to return to the unrestrained shape and pull away from the releasable adhesive.

The support product provides secure, repositionable, and nonpermanent support by interposing a soft, conforming pad between the unmounted medium and the mounting surface. The conforming pad conforms shapewise to the unmounted medium as the medium changes shape over time.

A releasable adhesive is fixed to a first side of the conforming pad and bonds the unmounted medium to the pad.

The conforming pad assumes the shape of the unmounted medium and enables the adhesive to maintain contact with the medium over a large contact area.

The large contact area strengthens the bond between the pad and the medium and keeps the medium from pulling away from the adhesive.

The conforming pad changes shape with and in response to the changing medium and maintains the large contact area as the medium returns to the unrestrained shape.

The product also comprises a fastener fixed to the conforming pad. The fastener extends outwardly from a second side of the conforming pad and engages a mounting surface, such as a wall, a cabinet, and a desktop, so that the unmounted medium can be displayed and positioned as desired.

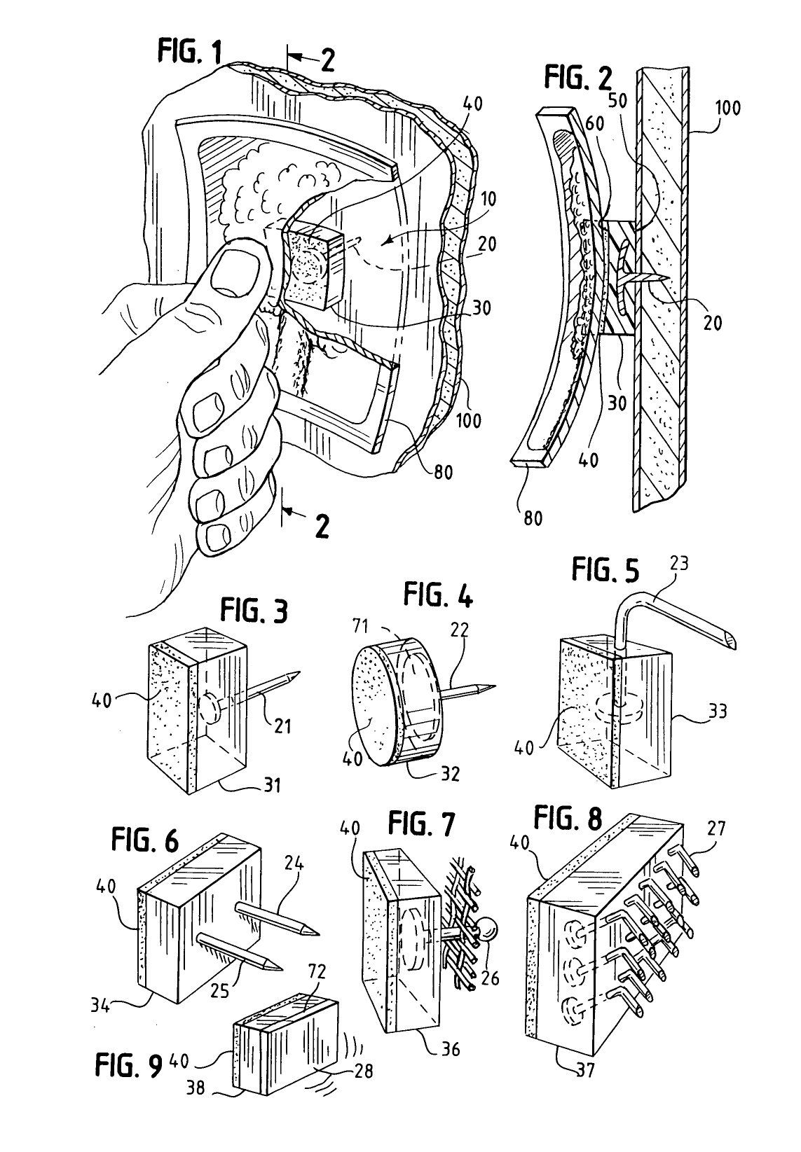

FIG. 1 is a perspective view of a product in use holding an unmounted medium. The cutaway portion shows a fastener 20, an adhesive 40, and a conforming pad 30, of the product 10.

FIG. 2 is a section view across line 2-2 of FIG. 1. In this view the medium 80 has assumed an unrestrained shape and the conforming pad can be seen conforming to the unrestrained shape.

FIG. 3 is a perspective view of another embodiment of the product.

FIG. 4 is a perspective view of another embodiment of the product.

FIG. 5 is a perspective view of another embodiment of the product.

FIG. 6 is a perspective view of another embodiment of the product.

FIG. 7 is a perspective view of another embodiment of the product.

FIG. 8 is a perspective view of another embodiment of the product.

FIG. 9 is a perspective view of another embodiment of the product.

Various support devices are used for hanging and holding unmounted media such as photographs, postcards, index cards, memos and various other media. In office environments such media are positioned on cubicle walls, file cabinets, and other surfaces to enhance the appearance of the work area and to display personal and business-related items.

There is a need for a support product that provides secure, repositionable, and nonpermanent support so that the medium can be repositioned and replaced without damaging the medium and the support product. For example, media can be repositioned for better centering and outdated media can be replaced with up-to-date media.

The support product comprises a conforming pad for conforming shapewise to the unmounted medium. The conforming pad has a first side and a second side.

A releasable adhesive is fixed to the first side of the pad. The releasable adhesive can be fixed to all of the first side and fixed to a portion of the first side. The releasable adhesive engages the unmounted medium and bonds the medium to the conforming pad.

Here and throughout, releasable adhesive refers to a material that exhibits sufficient adhesion to bond and support unmounted media and insufficient adhesion to damage unmounted media when the medium is detached from the adhesive. A common example is the releasable, low-tack adhesive used in pads of office memo notes that can be pulled from the pads and adhered to various surfaces such as computer monitors and office doors.

Various other compounds and materials that provide releasable adhesive properties can also be used.

Releasable adhesives typically provide less bonding strength than permanent adhesives. Releasable adhesives can fail over time when used to bond unmounted media to a mounting surface because the medium tends to change shape over time and pull away from the mounting surface. As the medium pulls away from the mounting surface, the part of the medium in contact with the adhesive gets smaller and reduces the bond between the mounting surface and the medium.

The conforming pad conforms shapewise to the medium by assuming the initially distorted shape of the medium and then changing with the medium as the medium returns to the unrestrained shape. Because the conforming pad changes shape over time with the unmounted medium, the adhesive maintains contact with the medium over a large area and the tendency of the medium to pull away from the adhesive over time is minimized.

The ability of the conforming pad to change shape with and in response to the changing shape of the unmounted medium distinguishes the support product from the prior art.

FIG. 1 shows a support product 10 in use positioning the unmounted medium 80 on a mounting surface 100. The support product 10 has a fastener 20 fixed to the conforming pad 30. The fastener 20 engages the mounting surface and holds the product and the medium to the mounting surface.

The medium can be distorted from the unrestrained shape when the medium is attached to the support product and when the support product engages the mounting surface.

In FIG. 1, for example, the support product 10 holding the unmounted medium 80 can be pushed into the mounting surface 100 and the medium can be distorted from the unrestrained shape.

Internal forces within the distorted medium tend to bias the medium towards returning to the unrestrained shape. Over time the internal forces can cause the medium to separate from the releasable adhesive and detach from the mounting surface.

The releasable adhesive in use bonds the first side of the conforming pad to the unmounted medium so that the pad assumes the shape of the medium where the adhesive contacts medium.

FIG. 2 shows a section view of the support product 10. The fastener 20 extends outwardly from the conforming pad second side 50 and engages the mounting surface 100. The releasable adhesive 40 is fixed to the conforming pad first side 60 and bonds the medium 80 to the conforming pad 30.

In FIG. 2, the medium has changed from the initially distorted shape to the unrestrained shape. The conforming pad 30 has changed shape with and in response to the changing medium. The pad first side 60 has assumed the shape of the medium where the medium contacts the pad.

The conforming pad comprises a soft, pliable material that can change shape to conform to the changing shape of the unmounted medium. The conforming pad can be comprised of various materials provided that the material is sufficiently soft and pliable to change shape with and in response to the changing medium. Some conforming pad materials can include, but are not limited to polyurethane, polyethylene, vinyl, acrylic and various other materials.

The conforming pad can have various shapes. In FIGS. 1, 2, 3, 5, 6, 7, 8, and 9, the conforming pads 30, 31, 33, 34, 36, 37, and 38 are substantially rectangular prisms. In FIG. 4, the pad 32 is cylindrical. The conforming pad can be curvilinear, pyramidal, polygonal, irregular, and various other shapes and combinations thereof.

The support product further comprises a fastener fixed to the conforming pad. The fastener engages the mounting surface, such as a wall, cabinet, desktop and various other surfaces, to hold the support product and unmounted media to the mounting surface.

The fastener extends outwardly from the second side of the conforming pad to engage the mounting surface.

The fastener is securely fixed to the conforming pad so that the pad and fastener provide a one-piece support product for the media. The fastener can be fixed to the pad in various ways.

The fastener can be embedded in the pad as shown in FIGS. 1, 2, 3, 5, 7, and 8 by casting and molding the fastener into the pad. Alternatively, the fastener can be embedded in the pad by inserting the fastener into the pad.

Alternatively, the fastener can be threaded and screwed into the pad.

Alternatively, the fastener can have features the capture and hold portions of the pad, for example crimping features that can be displaced to grip and hold the pad.

Alternatively, the fastener can have features that provide a bonding surface for an adhesive fixed to the second side of the pad. For example, a thumbtack head can be bonded to the second side of the pad so that the tack extends outwardly from the second side. In FIG. 4, the fastener 22 is fixed to the conforming pad 32 via the bonding surface 71. In FIG. 9, the magnetic fastener 28 is fixed to the conforming pad 38 via the bonding surface 72.

Various types of fasteners can be used, for example, post, hook, and magnetic fasteners, hook portions of hook and loop fasteners, loop portions of hook and loop fasteners, and various other types of fasteners.

Different fasteners can be used to engage different types of mounting surfaces. For example, a post fastener with a pointed end distal the second side of the conforming pad can be used for soft materials such as cork, foam, gypsum board, soft wood, and other soft materials. In FIGS. 1, 2, 3, 4, 5, and 6, the fasteners 20, 21, 22, 23, 24, and 25 are post fasteners with pointed ends.

Alternatively, a post fastener with a bulbous end distal the second side of the conforming pad can be used to engage fabric-covered cubicle walls. In FIG. 7, the fastener 26 is a post fastener with a bulbous end.

Alternatively, a magnetic fastener can be used to engage metal surfaces. In FIG. 9, the fastener 28 is a magnetic fastener.

Some fasteners can be used to engage more than one type of mounting surface.

The fastener can comprise a plurality of fastener components. For example, a post fastener can have more than one post fastener component and a hook fastener can have more than one hook fastener component. In FIG. 6, the fastener comprises a plurality of post fastener components, such as the post fastener component 24. In FIG. 8, the fastener comprises a plurality of hook fastener components, such as the hook fastener component 27.

Alternatively, a plurality of fastener components can comprise different types of fastener components; for example, a plurality of fastener components can comprise at least one post fastener component and at least one hook fastener component and various combinations thereof.

A plurality of fastener components can be useful to limit the rotation of the support product on the mounting surface and to strengthen the engagement between the product and the mounting surface.

Other types of fasteners can be used so long as they provide the function of engaging the mounting surface and holding the support product and medium to the mounting surface.

The mounting surface can be vertical, horizontal, and at an arbitrary angle.

1. A support product for holding unmounted media, the product comprising:
a conforming pad for conforming shapewise to the unmounted medium,
the conforming pad having a first side and a second side;
a releasable adhesive for engaging the unmounted medium,
the adhesive being fixed to the first side of the conforming pad;
the adhesive in use bonding the first side of the conforming pad to the unmounted medium so that the pad assumes the shape of the medium where the adhesive contacts the medium;
a fastener for engaging a mounting surface,
the fastener being fixed to the conforming pad; and
the fastener extending outwardly from the second side of the conforming pad.

2. The product of claim 1 wherein the fastener comprises a post having a pointed end distal the second side of the conforming pad.

3. The product of claim 1 wherein the fastener comprises a post having a bulbous end distal the second side of the conforming pad.

4. The product of claim 1 wherein the fastener comprises a magnet.

5. The product of claim 1 wherein the fastener comprises a hook portion of a hook and loop fastener.

6. The product of claim 1 wherein the fastener comprises a loop portion of a hook and loop fastener.

7. A support product for holding unmounted media, the product comprising:
a conforming pad for conforming shapewise to the unmounted medium,
the conforming pad having a first side and a second side;
a releasable adhesive for bonding the unmounted medium to the conforming pad,
the adhesive being fixed to the first side of the conforming pad;
the adhesive in use bonding the first side of the conforming pad to the unmounted medium so that the pad assumes the shape of the medium where the adhesive contacts the medium;
a fastener for engaging a mounting surface,
the fastener being fixed to the conforming pad;
the fastener having a plurality of fastener components, and
any fastener component from the plurality of fastener components extending outwardly from the second side of the conforming pad.

8. The product of claim 7 wherein a fastener component from the plurality of fastener components comprises a post having a pointed end distal the second side of the conforming pad.

9. The product of claim 7 wherein a fastener component from the plurality of fastener components comprises a post having a bulbous end distal the second side of the conforming pad.

10. The product of claim 7 wherein a fastener component from the plurality of fastener components comprises a magnet.
